(19) United States
(12) Patent Application Publication
(10) Pub. No.: US 2004/0181675 A1
(43) Pub. Date: Sep. 16, 2004

(54) Process for verifying the identity of an individual over a computer network, which maintains the privacy and anonymity of the individual's identity characteristic

(76) Inventor: Marc William Hansen, Bremerton, WA (US)

Correspondence Address: Marc William Hansen, 3231 Erlands Point Rd, N.W., Bremerton, WA, 98312, US

(21) Appl. No.: 10/797,853

(22) Filed: Mar. 10, 2004

Related U.S. Application Data
(60) Provisional application No. 60/454,088, filed on Mar. 11, 2003.

(51) Int. Cl. H04L 9/00

(52) U.S. Cl. 713/182

(57) ABSTRACT

A process for verifying the identity of an idividual over a computer network, which maintains the privacy and anonymity of the individuals identity characteristic with the steps of: At least one computer on the network acts as an authentication server, it has a unique network address, At least one computer on the network acts as a name server, it has a unique network address, Individuals enroll when an exemplar signature is captured and sent to authentication server, Authentication server stores exemplar signature and assigns it a unique network address, Authentication server sends unique network address (a “virtual signature”) to enrolling individual, Identity of enrolled individual authenticated when sample signature sent to address of “virtual signature”, Authentication server compares exemplar signature to sample signature, and Authentication server returns result of comparison to sender.

### CROSS REFERENCE TO RELATED APPLICATIONS

This application is based on provisional application serial No. 60/454,088, filed on Mar. 11, 2003.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of identity authentication and more specifically to a process for verifying the identity of an individual over a computer network, which maintains the privacy and anonymity of the individual's identity characteristic.

The economy of the world is quickly becoming one which both depends on computer networks, such as the Internet, and on knowing, with a high degree of certainty, the identity of individuals. Financial transaction, air travel, entrance at national borders, and applications for employment are just a few of the situations where the identity of individuals must be verified.

For example an individual makes a purchase at a retailer by:

1. Giving their credit card to the clerk at the check-out counter.

2. The card is swiped through a card reader and the transaction is sent electronically through the Internet.

3. The individual's identity is verified when the clerk visually inspects the card holder's signature, on the back of the card, with the signature just given on the credit card withdrawal authorization slip.

Another example is given by an individual who travels using an airline ticket bought over the World Wide Web:

1. The individual purchases a ticket on their personal computer using forms managed over the Web, and receives a confirmation number.

2. The individual checks in at an airport kiosk by entering their confirmation number.

3. The individual proves their identity by showing a government-issued card (e.g., a state issued driver's license) to an airline counter agent, who compares the photo image on the card with the person standing in front of them.

Yet a third example is given by an individual gaining access to a private computer network (such as a bank's wide area network):

1. The individual is first authorized to use the network, and is then given a password by the network system administrator.

2. The individual enters their user name and password and the network S/W checks the password to determine if it is valid for that user name, and if so, the individual is granted access to the network.

3. Thus the individual proved their identity by knowing a valid password.

And finally a fourth example is given by withdrawing funds from an ATM at a credit union branch office:

1. The individual places their finger on a fingerprint scanner, and enters their account number, and user identification.

2. The fingerprint just sampled is compared to an exemplar stored in the credit unions computer for that user. If it matches, the funds are released and deducted from the individual's account

3. Thus the individual proved their identity by storing their exemplar print with the credit union to be used for later identity authentication.

In the first example verification of identity was provided by the clerk's judgment in comparing two handwritten signatures. In the second example an airline agent compared the face of an individual standing before them with a photo image on a card. In the third example knowledge of a user name and a corresponding password “proved” the individual's identity. In the fourth a stored fingerprint matched a sampled print which verified the individual's identity.

The common element in the 4 situations outlined above is that the individual presented evidence that could corroborate their claim that they were a certain named individual.

These examples could be multiplied almost indefinitely because the need for identity verification has become necessary for society to conduct almost all affairs of business and to protect itself against those who would commit crimes against it. The need for identity authentication in today's world is apparent.

However, there is also concern among many of those individuals who make up society, that systems that verify identity, also attack personal privacy and make the individual less secure against those who would misuse it. Thus society is caught between two opposing forces. The need to verify identity by making each individual more public, and the need of many individuals to maintain some control over their own lives.

There are many existing approaches to authenticating, or verifying the identity of an individual. They use everything from something that an individual carries (for example a passport, or a drivers license), to something inherent to the individual (for example biometrics), to something that an individual knows (for example a password, or answer to a secret question).

The systems uniformly use something that must be stored. Thus, for example, a driver's license must be stored in an individual's pocket with a copy at the state licensing department. As another example, the fingerprint is at the end of an individual's arm with an exemplar stored in a computer database. The password, or secret-question answer is stored in an individual's head (or perhaps pocket) as well as in a computer database.

The literature and market place have an enormous number of references to various methods. Also examples of these methods and approaches are disclosed in:

U.S. Pat. No. 4,837,422 to Dethloff et al.

U.S. Pat. No. 4,998,279 to Weiss

U.S. Pat. No. 4,821,118 to Lafreniere

U.S. Pat. No. 4,993,068 to Piosenka et al.

U.S. Pat. No. 4,995,086 to Lilley et al

U.S. Pat. No. 5,054,089 to Uchida et al.

U.S. Pat. No. 5,095,194 to Barbanell

U.S. Pat. No. 5,109,427 to Yang

U.S. Pat. No. 5,109,428 to Igaki et al.

U.S. Pat. No. 5,144,680 to Kobayashi et al.

U.S. Pat. No. 5,146,102 to Higuchi et al.

U.S. Pat. No. 5,168,520 to Weiss

U.S. Pat. No. 5,180,901 to Hiramatsu

U.S. Pat. No. 5,210,588 to Lee

U.S. Pat. No. 5,210,797 to Usui et al.

U.S. Pat. No. 5,222,152 to Fishbine et al.

U.S. Pat. No. 5,230,025 to Fishbine et al.

U.S. Pat. No. 5,239,538 to Parrillo

U.S. Pat. No. 5,241,606 to Horie

U.S. Pat. No. 5,251,259 to Mosley

U.S. Pat. No. 5,265,162 to Bush et al.

U.S. Pat. No. 5,276,314 to Martino et al.

U.S. Pat. No. 5,321,242 to Heath, Jr.

U.S. Pat. No. 5,325,442 to Knapp

U.S. Pat. No. 5,343,529 to Goldfine et al.

U.S. Pat. No. 5,351,303 to Willmore

More germane to the present invention is a tokenless identification system and method for authorization of transactions and transmissions described in U.S. Pat. No. 5,613,012 to Hoffman et al. In this system the individual initially registers with the system (1) an authenticated biometric sample, (2) a personal identification code and (3) a private code.

Thereafter, during an authentication of that individual (a “bid step”) the biometrics sample and personal identification code of the individual is gathered and compared to the ones registered during the initial registration step. A match of the personal identification codes and biometrics sample will result in the positive identification of the individual. In order to authenticate to the identified individual that the real computer system was accessed, the individual's private code, which was collected at the registration step, is returned to the individual.

Extensions of this tokenless system are described in:

U.S. Pat. No. 6,192,142 to Pare et al

U.S. Pat. No. 6,154,879 to Pare et al

U.S. Pat. No. 6,012,039 to Hoffman et al

U.S. Pat. No. 5,838,812 to Pare et al

U.S. Pat. No. 5,805,719 to Pare et al

U.S. Pat. No. 5,802,199 to Pare et al

U.S. Pat. No. 5,764,789 to Pare et al

To the best of my knowledge there is no existing system, nor does any system described in prior art address the problem of implementing a method of authenticating the identity of individuals while providing a means to protect, and provide anonymity for the individual's identifying characteristic, and at the same time provide a simple network-centric way to authenticate that individual's identity using a network.

The present invention is clearly advantageous over the prior art in a one essential way. Namely it protects the anonymity of individuals who enroll in the authentication network. That is to say, an individual can enroll by providing an exemplar signature without giving any other information. The exemplar signature is stored in an authentication server and the unique network address of that exemplar signature is returned to the individual. The individual now possesses that unique network address and can use it, at their discretion, in collaboration with 3rd parties.

That is to say, the 3rd party can always verify that the person who submits a sample signature in the presence of the 3rd party is the owner of a claimed virtual signature by sending the sample signature to the network address given by the “virtual signature”.

### BRIEF SUMMARY OF THE INVENTION

The primary object of the invention is to provide a means of maintaining anonymity of an individual's identity characteristic in an identity authentication system.

Another object of the invention is to provide a means for third parties to verify the identity of individuals using an authentication system which implements said anonymity.

Another object of the invention is to provide a means of implementing an identity authentication network which allows individuals to own anonymous identity characteristics.

A further object of the invention is to provide a means of implementing an identity authentication network.

Yet another object of the invention is to provide a means of implementing an identity authentication network which uses the World Wide Web.

Still yet another object of the invention is to provide a means of implementing an identity authentication system that reduces the privacy concerns of many citizens.

Another object of the invention is to provide a means of implementing an identity authentication system that allows individuals to choose what identity characteristic (s) to use for identification.

Another object of the invention is to provide a means of implementing an identity authentication system that allows third parties to specify what identity characteristic (s) they use for identification.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process for verifying the identity of an idividual over a computer network, which maintains the privacy and anonymity of the individual's identity characteristic comprising the steps of: At least one computer on the network acts as an authentication server, it has a unique network address, At least one computer on the network acts as a name server, it has a unique network address, Individuals enroll when an exemplar signature is captured and sent to authentication server, Authentication server stores exemplar signature and assigns it a unique network address, Authentication server sends unique network address (a “virtual signature”) to enrolling individual, Identity of enrolled individual authenticated when sample signature sent to address of “virtual signature”, Authentication server compares exemplar signature to sample signature, and Authentication server returns result of comparison to sender.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a diagram illustrating the registration of an Authentication Server with the Authentication Network Name Server.

FIG. 2 is a diagram illustrating the enrollment of an individual in the system covered by this invention. It shows that an individual receives a “virtual signature” which is the unique network address of the submitted exemplar signature.

FIG. 3 is a diagram illustrating that for authentication a sample signature is sent to the network address given in the “virtual Signature”.

FIG. 4 is a flow chart illustrating a client transaction sending an authentication request containing “virtual Signature” along with a sampled signature.

FIG. 5 is a flow chart illustrating the Name Server receiving an authentication request and extracting the Authentication Server address from the “virtual signature”.

FIG. 6 is a flow chart illustrating the Name Server receiving an authentication request and extracting, from the “virtual signature”, the database location for the stored exemplar signature, and then comparing it to the received sample signature.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The invention performs identity verification anywhere in the world using the internet, the World Wide Web, or any computer network. It is a uniquely flexible system which can allow identity verification, while at the same time allowing any level of personal anonymity.

This system provides “virtual signatures” which an individual owns. These virtual signatures are just unique numbers which encode two things. First, an IP address of a computer which contains a database, and second, a database key to a particular record on that database. The database record contains a digital representation of a signature unique to that individual (for example, a fingerprint). Then, for example, the virtual signature can be placed on a credit card, or an ID card, or placed in an electronic file, and so on. For the case where the individual carries a card, then the card carries the virtual signature, and they innately possess the actual signature, (for example, the fingerprint is at the end of their arm). When that individual's identity needs to be verified, this invention then uses the virtual signature to bind the actual (sampled) signature to the database (exemplar) signature.

For the purpose of this invention, the term “identity characteristic”, the term “token”, and the term “signature” are taken as synonomous. For example, a password or a fingerprint are both elements that could be, and are used to make a determination of identity. In this document they are variously called “identity characteristic”, or “token”, or “signature”.

This system process works as follows:

0. This description assumes that a certain technical infrastructure exists. This invention uses that infrastructure. For instance it assumes the internet, the World Wide Web, biometric readers/scanners, point-of-sale terminals with biometric readers/scanners, ticket counters with web-enabled computers with biometric readers/scanners connected to (e.g., USB) data ports, etc.

1. One (or more) computer(s) are Name Servers. They contain a list of registered Authentication Servers. Every authentication request is sent to the Name Server.

2. An authentication request is composed of a minimum of two parts. The first part is the “virtual signature”, the second part a sampled signature data set.

3. The “virtual signature” is composed of two parts. The first part is the network address of an Authentication server. The second part is the location in a database contained in the Authentication Server of an exemplar signature. (For example using standard IP address notation a “virtual signature” might appear as 127.101.0.19:34567, or as a Web address it might appear as www.AuthenServer.com:34567)

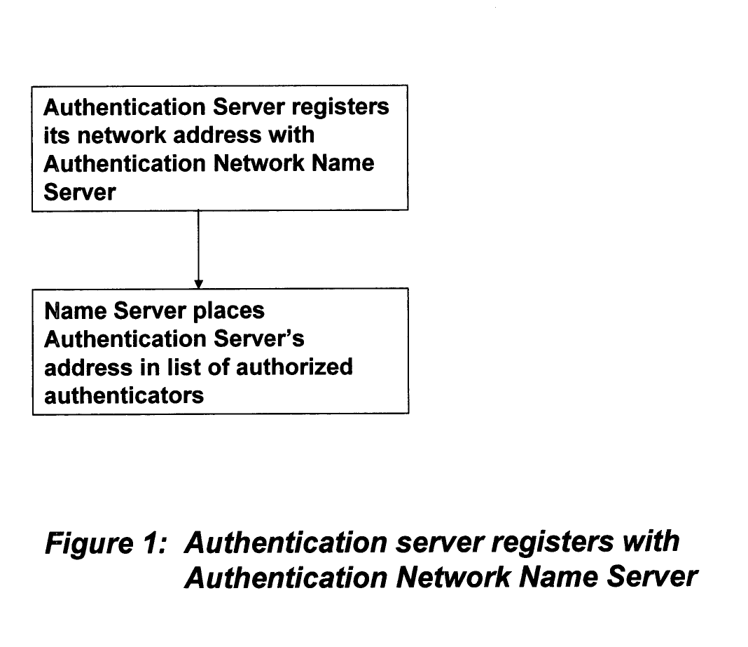

4. An Authentication Server first registers with the Name Server, which places the network address of the Authentication Server in a list of registered Authentication Servers. (For example if a computer at IP address 127.101.0.19 registered with the Name Server then address 127.101.0.19 would be in its list of registered Authentication Servers, or alternately www.AuthenServer.com would be in the list). This is shown in FIG. 1.

5. An individual “enrolls” at any Authentication Server they choose and at which they are allowed to enroll. How the individual chooses, and how the Authentication Server allows are unspecified. It is up to individuals and Authentication Servers. However the Authentication Servers will not be registered unless they satisfy certain security requirements.

6. When the individual enrolls, they submit an exemplar signature. An exemplar signature is (for the purpose of this invention) defined as any characteristic that is unique to, or would define that individual. For example an exemplar signature could be a fingerprint, iris print, voice print, handwritten signature, password, answer to secret question, physical description, photograph, etc.

7. In the preferred embodiment of this invention the individual need give no other information than an exemplar signature. They maintain complete privacy and anonymity, However a particular Authentication Server might have an enrollment policy that had specific requirements to enroll.

8. The Authentication Server stores the exemplar signature and returns the unique virtual signature of that submitted exemplar signature to the individual.

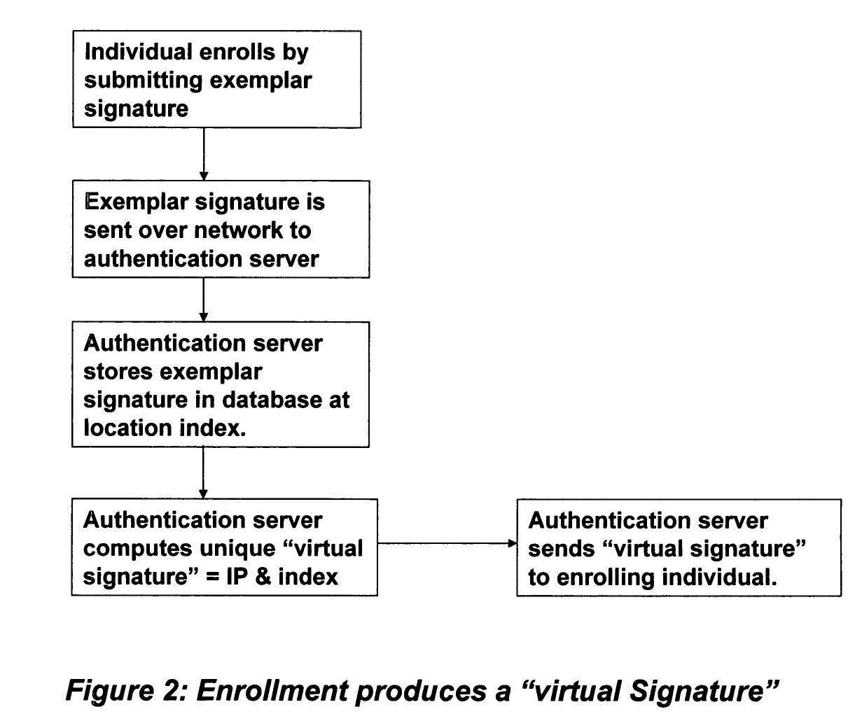

9. The individual is considered to own the “virtual signature”. This is shown in FIG. 2.

10. The individual can then use that virtual signature on client media. For the purposes of this invention, a client is defined as any organization which uses this system to verify the identity of individuals. For example VISA could be a client. Client media is defined as any media which might use, or contain the virtual signature. For example, VISA could magnetically imprint an individual's virtual fingerprint on a VISA card issued to that individual.

11. When the individual needs to have their identity authenticated as part of some transaction, they submit a sample signature of the same kind associated with their virtual signature. For example if they have an exemplar fingerprint stored at www.AuthenServer.com:34567, then they would submit a sample fingerprint. So continuing the example, if that individual was at an airline ticket counter they would place their thumb on a scanner connected to the airline agent's computer (called a client computer for the purpose of this invention), and scanner software would capture their fingerprint.

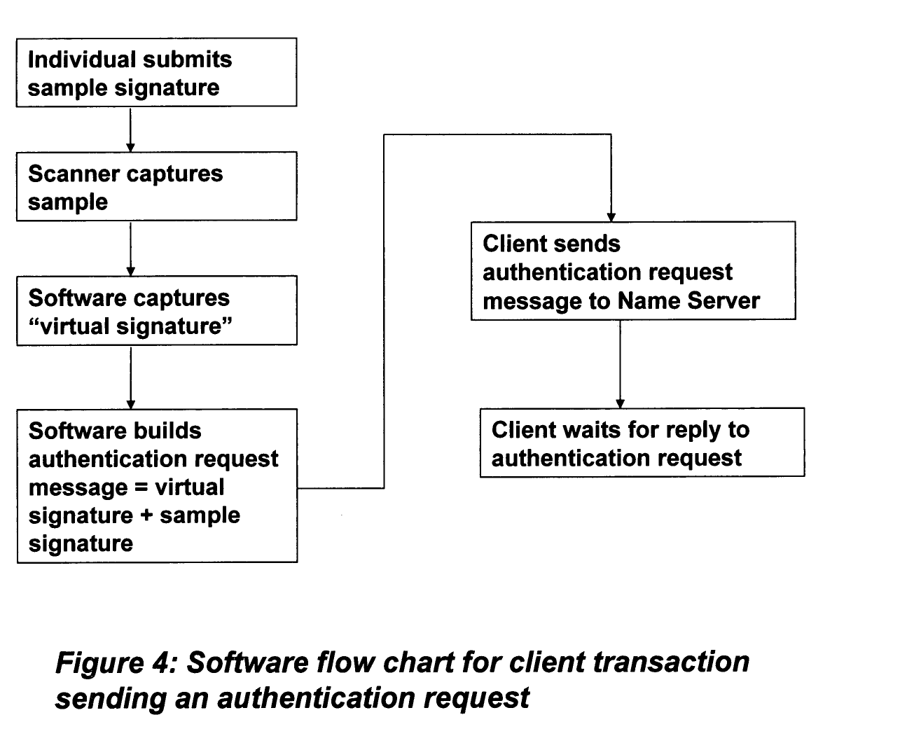

12. An authentication request (as in 2 above ) is created by client software (running on a client computer) and sent to the Name Server. This is shown in FIG. 4.

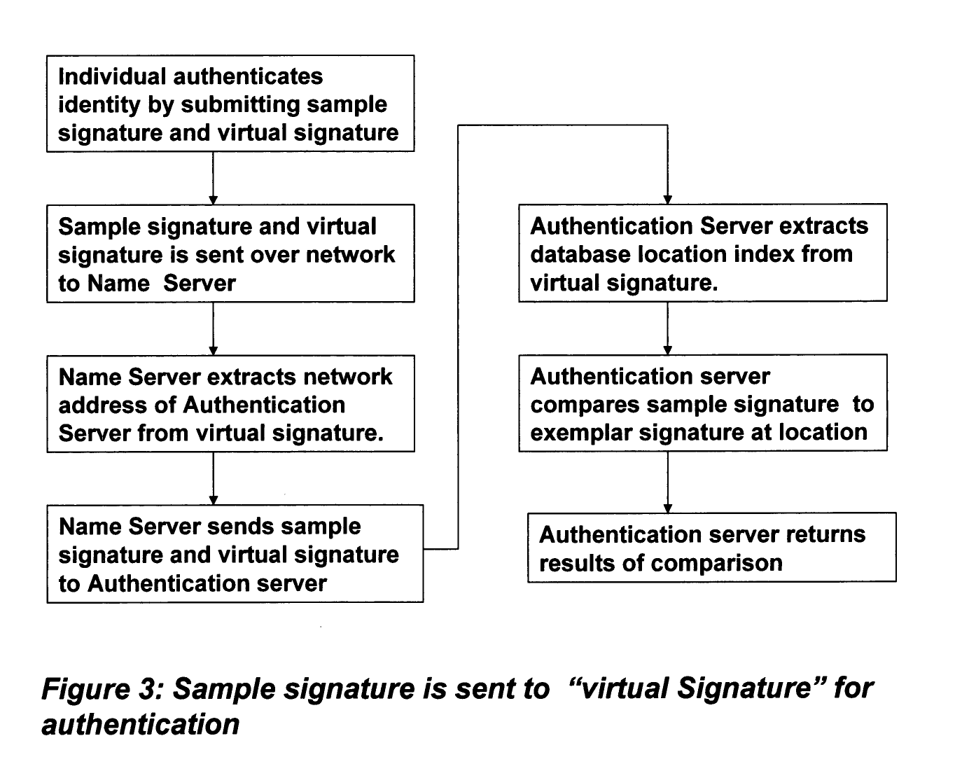

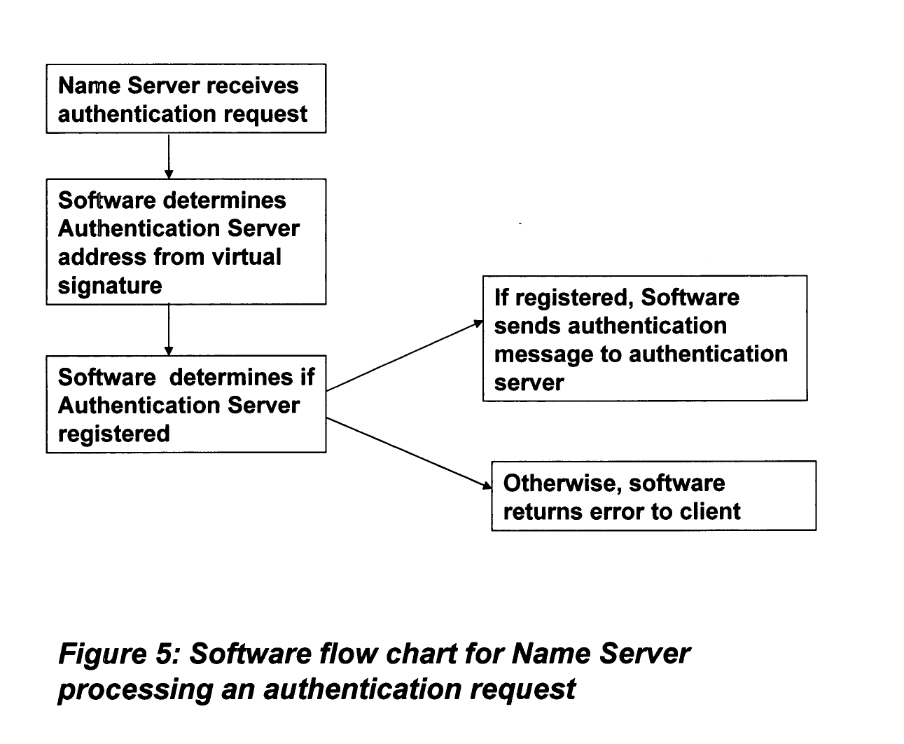

13. The Name Server extracts (from the received virtual signature) the network address of the Authentication Server. If this address is for a registered Authentication Server, then it passes the authentication request to it. If it is not a registered address, it returns an error to the client. This is shown in FIG. 3 and in FIG. 5.

14. When the Authentication Server receives an authentication request, it extracts (from the received virtual signature) the database index of an exemplar signature.

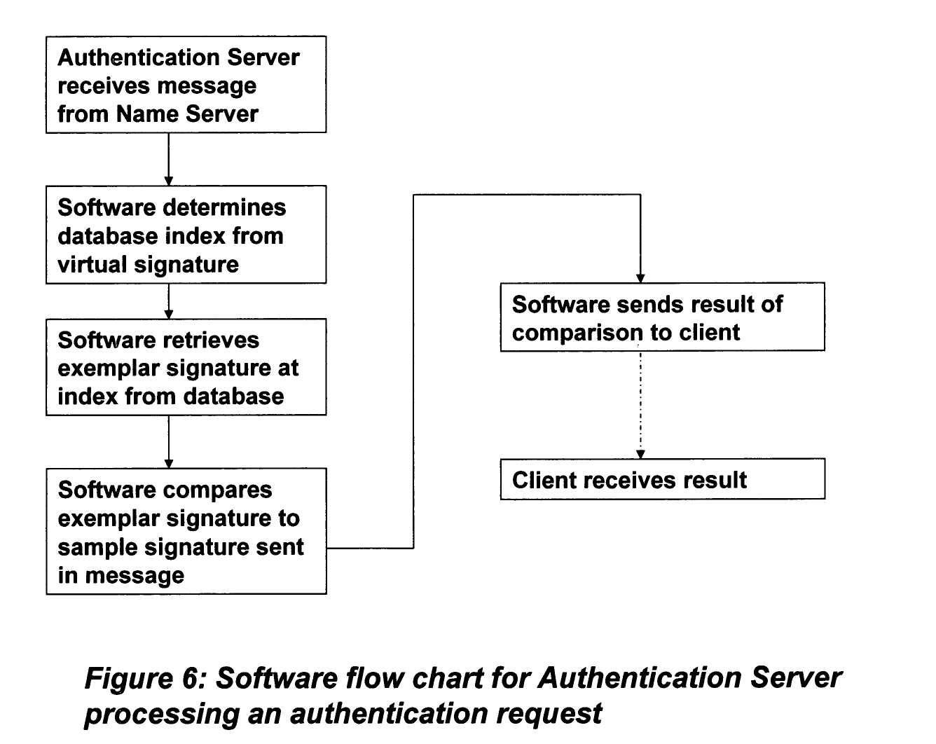

15. It retrieves that exemplar signature and compares it to the received sample signature. It then returns the result of that comparison to the client. This is shown in FIG. 6.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A process for verifying the identity of an individual over a computer network, which maintains the privacy and anonymity of the individual's identity characteristic (also known as “token” or “signature”). comprising the steps of:
At least one computer on the network acts as an authentication server, it has a unique network address;
At least one computer on the network acts as a name server, it has a unique network address;
Individuals enroll when an exemplar signature is captured and sent to authentication server;
Authentication server stores exemplar signature and assigns it a unique network address;
Authentication server sends unique network address (a “virtual signature”) to enrolling individual;
Identity of enrolled individual authenticated when sample signature sent to address of “virtual signature”;
Name Server insures that Authentication Server is registered and has authority to receive and process authentication request;
Authentication server compares exemplar signature to sample signature; and
Authentication server returns result of comparison to sender.
